(19) United States
(12) Patent Application Publication
(10) Pub. No.: US 2011/0114621 A1
(43) Pub. Date: May 19, 2011

(54) Retort Furnace for Heat Treating Metal Workpieces

(76) Inventors: Rolf Sarres, Oberhausen (DE); Heinz Schwall, Eschweiler (DE)

(21) Appl. No.: 13/012,206

(22) Filed: Jan. 24, 2011

Related U.S. Application Data
(62) Division of application No. PCT/DE2009/000963, filed on Jul. 13, 2009.

(30) Foreign Application Priority Data
Aug. 8, 2008 (DE) 20 2008 010 550.1

(51) Int. Cl. H05B 3/00

(52) U.S. Cl. 219/213

(57) ABSTRACT

An electrically heated retort furnace for the heat treatment of metal workpieces comprises a furnace housing having retort, a heating unit, and a circulation unit, in which, to increase the efficiency of the heat treatment by more uniform heating of the retort, the heating unit has multiple heating elements, which are situated so they are at least individually replaceable in the first volume space using closable first openings incorporated in the furnace housing, a second circulation unit for circulating the air in the first volume space is received by the furnace housing and is situated so it is replaceable as a module using a closable second opening, and the heating elements and circulation unit are received in the first volume space.

### CROSS REFERENCE TO RELATED APPLICATIONS

This application is a Division of International Application No. PCT/DE2009/000963 filed Jul. 13, 2009 which designates the United States. The entire disclosure of said international application is incorporated herein by reference.

### BACKGROUND OF THE INVENTION

1. Field of the Invention

The invention relates to a retort furnace for the heat treatment, for example, the blank annealing, annealing under nitrogen or nitrogen/hydrogen, nitriding, or nitrocarburizing of metal workpieces, the retort furnace includes a furnace housing having a retort, a heating unit, and a circulation unit.

2. Description of the Related Art

Such retort furnaces for the heat treatment of metal workpieces are known in manifold configurations according to the prior art, for example, according to DE-AS 2 010 433, DE-OS 27 54 034, DE 30 28 952 C2, DE 31 43 532 A1, DE 36 31 389 C2, and DE 103 38 431 A1.

The heating units and circulation units in retort furnaces receive particular significance because of the uniform heating to be achieved of the workpieces to be treated in the interior of the retort.

Such retort furnaces may be heated using electrical heating elements or gas burners. The heating unit is typically situated in the space between the furnace housing, which has thermal insulation on the inner side, and the retort.

With gas burners, the flame generates a gas stream in the space between furnace housing and retort; as a result of this gas stream, the heating of the retort is performed by radiation and convection, whereby uniform heating of the retort is implemented.

In electrically heated retort furnaces, the electrical heating elements are also situated in the space between furnace housing and retort. For example, the heating elements are arranged in a winding pattern and are guided on the inside of the furnace housing, in order to heat the workpieces to be treated in the furnace space of the retort uniformly to a desired temperature such as 650° C., for example. The heat transfer from the heating elements to the retort exclusively occurs through radiation, however, the convective component, which decisively contributes to equalization in the case of gas heating, is missing in the case of electrical heating.

For the intensive circulation of the furnace atmosphere, which encompasses the whole product being heat treated, high-performance circulation units are used within the retort, whose functional interaction must be adapted in heating technology with the heating units. Therefore, it was apparently advantageous according to the prior art to perform the circulation of the furnace atmosphere in the furnace space within the retort. Accordingly, the corresponding units such as circulation assembly and gas guiding aids were only used inside the retort.

### BRIEF SUMMARY OF THE INVENTION

The object of the invention is, in electrically heated retort furnaces, to increase the efficiency of the heat treatment through more uniform heating of the retort and therefore also of the workpiece batches which are located within the retort, and to prevent, through the most uniform possible heating of the retort, local overheating and thermal strains, which have negative effects on the service life of the retort.

This object is achieved according to the invention in a retort furnace for the heat treatment of metal workpieces,
which has a thermally insulated furnace housing, which encloses a first volume space, having a heating unit for the retort and a first circulation unit within the retort,
the retort enclosed by the first volume space enclosing a treatment or charge space, which receives the protective and reactive gases and is closable gastight using a door for the charging of a batch of workpieces, for the heat treatment of the workpieces contained in a batch receptacle, wherein
   a) the heating unit has multiple heating elements, which are constructed and arranged so they are at least individually replaceable in the first volume space using closable first openings incorporated in the furnace housing and
   b) a second circulation unit for circulating the atmosphere in the first volume space is located in the furnace housing and is constructed and arranged so it is replaceable as a module using a closable second opening in the furnace housing, and
   c) the heating elements and circulation unit are received in a configuration in the first volume space which results in a uniform heat transfer to the retort.

According to one aspect of the present invention, a retort furnace is implemented so that the heating elements are oriented orthogonally to the longitudinal axis or extent of the retort, the heating elements have a length which exceeds the diameter of the retort, the heating elements have an unheated middle area, for example, in relation to their longitudinal extension, and/or at least two heating elements are provided along the longitudinal sides of the retort.

According to another aspect of the invention, a retort furnace is provided in which the second circulation unit has a circulation assembly and a conduction unit and/or the conduction unit is in a configuration which causes transverse circulation of the air in the furnace chamber in relation to the longitudinal extension of the retort.

According to another feature of the invention, the second opening is dimensioned and situated so that the second circulation unit is easily removable from the furnace housing.

The heating unit used in the retort furnace according to the invention preferably has a plurality heating elements. The heating elements are each implemented as bar-shaped elements, and are oriented essentially perpendicularly, i.e., orthogonally to the longitudinal axis of the retort, with respect to their longitudinal extent. A plurality of individual heating elements can be provided along the longitudinal sides of the retort. The use of three bar-shaped heating elements along each longitudinal side of the retort is preferred. The preferred arrangement provides a total of six heating elements.

In contrast to the winding heating elements known from the prior art, the heating unit designed according to the invention allows more uniform and therefore improved heating of the furnace space, which advantageously results in more uniform heating of the workpieces to be heat treated, which are situated in the retort. Because of this more equalized heating, essentially two advantages result. On the one hand, the more uniform heating of the retort results in a reduced thermally induced strain on the retort in comparison to the known furnaces, which results in a longer service life of the retort and thus of the retort furnace as a whole. On the other hand, a more uniform heating of the workpieces to be heat treated is achieved by the more uniform heating in the furnace, which provides better reproducibility of the heat treatment result. Because of the heating unit designed according to the invention, a furnace design results which allows proper method performance in an improved manner.

The retort is received in the furnace housing while leaving a gap space between the retort and the housing. The heating elements are situated in this gap space, i.e., between the retort on one side and the inner side of the furnace housing on the other side. The heating elements are preferably oriented parallel to one another, and have a first section, a second section, and a middle section formed between the first and second sections, which can also be referred to as the middle area. This middle area of the heating elements is not actively heated according to a special feature of the invention. According to this feature, the middle area does not itself generate heat when electrical energy is applied to the heating element 6. This design provides the advantage that overheating of the retort in this area is avoided, which could result because the heating elements are closest to the retort precisely in this area.

The heating elements are implemented as replaceable. “Replaceable” in the meaning of the invention is to be understood to mean that an individual heating element may be removed or replaced with a new heating element, independently of other heating elements in case of repair. In the heating units known from the prior art, this is disadvantageously not possible.

Circulating the furnace atmosphere in the retort inner space, i.e., the atmosphere in the actual useful space, i.e., the treatment space, is known from the prior art. It is proposed by the retort furnace according to the invention that a circulation unit be provided, independently of an atmosphere circulation in the interior of the retort provided under certain circumstances, using which the circulation of the atmosphere of the volume space enclosed by the furnace housing, i.e., the circulation of the atmosphere enclosing the retort, is achieved. This circulation is performed with the goal of achieving more uniform and thus improved heating of the retort by convection and therefore equalized heating of the workpieces to be heat treated, which are situated inside the retort.

This design according to the invention is additionally advantageous in that the much more uniform heating of the retort, which is caused by the circulating unit in contrast to the prior art, also results in a reduced thermal stress in comparison to the prior art. The service life of the retort and thus of the entire retort furnace is advantageously lengthened.

The circulation unit has a circulation assembly, on the one hand, and a conduction unit, on the other hand, according to one feature of the invention. The circulation assembly can be a motor-driven fan or the like, for example. The conduction unit is a module comprising baffle plates, for example which are used for forced guiding of the atmosphere, circulated using the circulation assembly. It is preferably provided that the conduction unit is implemented in such a manner that a transverse circulation oriented in relation to the longitudinal extension of the retort occurs. As a result of this transverse circulation, which circulates along the lateral surface of the retort and around the retort, the circulated gas atmosphere advantageously flows past the heating elements in the longitudinal direction thereof, so that a heat exchange between heating elements, on the one hand, and furnace atmosphere, on the other hand, can occur in an optimized manner.

The circulation unit is implemented as a modular building block, i.e., a module. It is inserted into a corresponding second opening in the furnace housing and has corresponding insulation for thermal insulation of the furnace housing in relation to the atmosphere enclosing the furnace housing, which is implemented in the form of a plug, for example, and thermally closes, i.e., seals, the opening implemented in the furnace housing after proper installation of the circulation unit according to the invention. Because of this design, simple installation or removal of the circulation unit according to the invention is possible, which is advantageous in particular in case of needed repair.

A combination of heating unit and circulation unit is proposed by the invention, which are advantageously functionally combined to provide a uniform effect, namely equalized heating of the retort, which is thus better in comparison to the prior art, and thus also improved heating of the workpieces to be heat treated, which are situated in the retort.

### BRIEF DESCRIPTION OF THE VIEWS OF THE DRAWINGS

In an exemplary embodiment of the invention, in the associated figures

FIG. 1 shows the longitudinal section of a retort furnace according to the invention and

FIG. 2 shows cross-section A-A from FIG. 1.

### DETAILED DESCRIPTION OF THE INVENTION

The invention will be described in greater detail on the basis of an example.

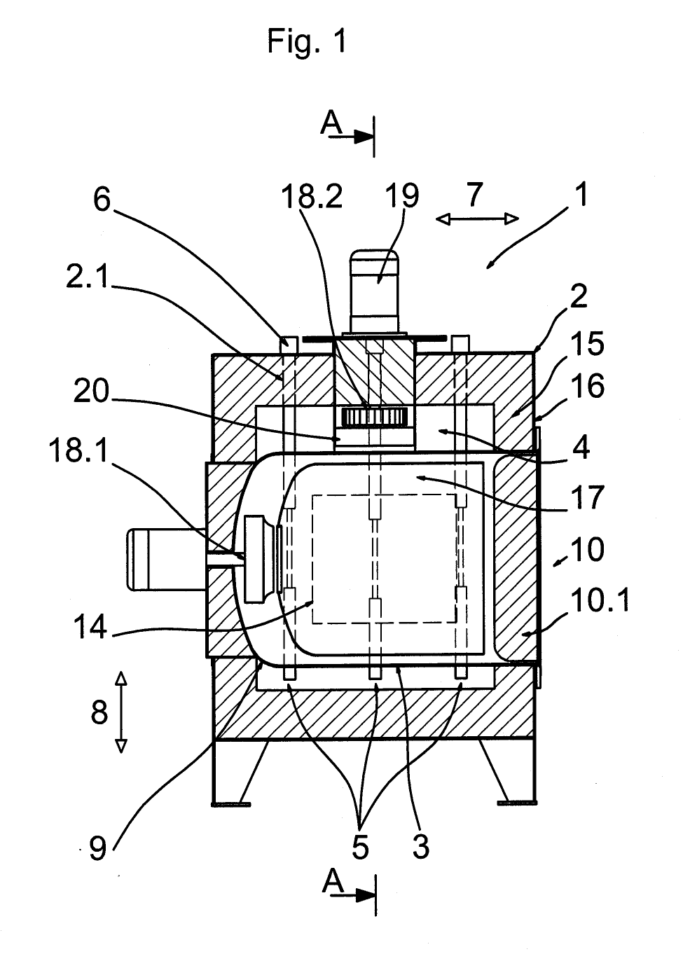

FIG. 1 shows a schematic view of a retort furnace 1 according to the invention in longitudinal section. In the exemplary embodiment shown, the retort furnace 1 is equipped with horizontally oriented retort 3, i.e., it is a horizontal retort furnace 1.

The retort furnace 1 has a furnace housing 2 having incorporated, closable first openings (2.1) for at least individually replaceable heating elements (6). The furnace housing 2 encloses a first volume space 4, within which the retort 3, a heating unit 5, and other features are situated. The furnace housing 2 accordingly receives the retort 3 and the heating unit 5. The retort furnace 1 furthermore has a first circulation unit 18.1 within the retort 3.

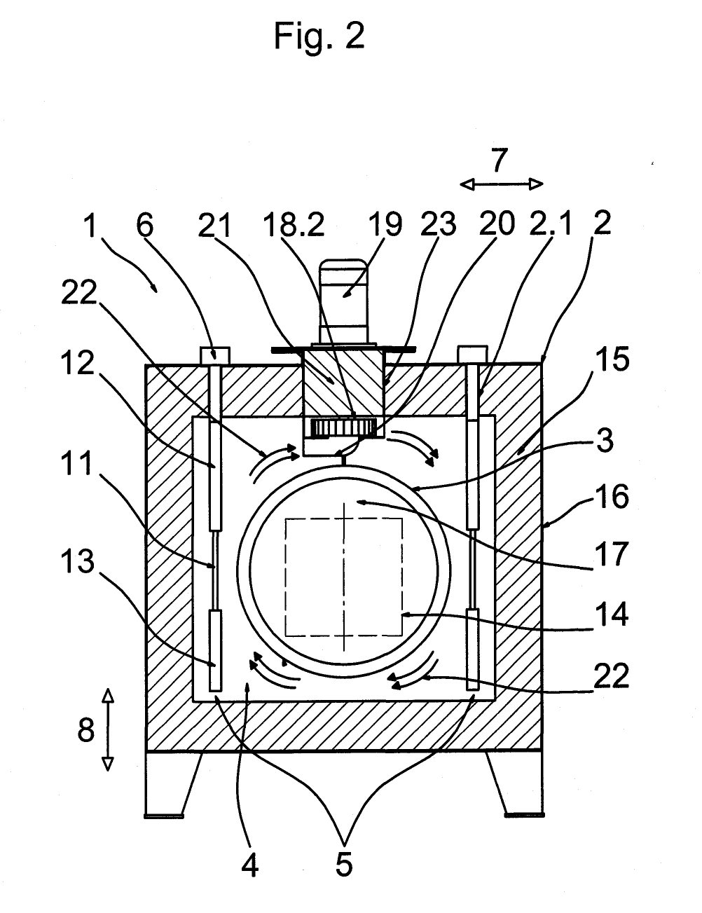

As may be seen in particular from the schematic illustration of FIG. 2, the furnace housing 2 comprises an outer wall 16, which is provided on the inside with insulation 15.

The retort 3 is implemented as a cylindrical hollow body. This hollow body is closed gastight at one end using a floor 9. With respect to the plane of the drawing according to FIG. 1, the retort 3 has a charging opening 10, opposite to the floor 9, which is closable gastight using a cover 10.1. A second volume space 17, which is enclosed by the retort 3, and which represents the actual useful space, i.e., the treatment space of the retort furnace 1, is accessible through the charging opening 10. Workpieces to be heat treated, which are assembled into a batch 14, for example, are placed in the retort 3 through the charging opening 10. Unloading of the retort is also performed through the charging opening 10.

The heating assembly 5 located in the furnace housing 2 is used for heating the first volume space 4, which is enclosed by the furnace housing 2, and which is generally referred to as the furnace space. As a result of the heating of the furnace space, due to heat transfer, heating of the retort 3 occurs and therefore also heating of the batch 14 situated in the interior of the retort 3.

The heating assembly 5 has a plurality of heating elements 6 as described above, which are each bar-shaped as shown in FIG. 2. The heating elements 6 are oriented with their longitudinal axes in the direction 8, as shown in FIG. 1 and also in FIG. 2. The retort 3 is oriented with its longitudinal axis in the direction 7, as show in FIG. 1.

As may further be seen from FIG. 1, the heating elements 6 have their longitudinal axes oriented orthogonally to the longitudinal axis of the retort 3. This relationship is also shown in FIG. 2.

With respect to the plane of the drawing of FIG. 2, each heating element 6 has a top section 12 and a bottom section 13. These two sections are connected to one another by the middle area 11. This middle area 11 is preferably implemented such that it is not actively heated and so that overheating of the retort 3 is prevented in this area.

As results from a consideration of FIG. 1 and FIG. 2 together, the retort furnace 1 according to the invention preferably has a total of six heating elements, three heating elements being provided on each side of retort 3, which are uniformly spaced in the direction 7.

The retort furnace 1 according to the invention has a second circulation unit 18.2 outside the retort 3 according to the invention. It has a circulation assembly 19, for example, in the form of a motor-driven fan or the like, and a conduction unit 20. The gas atmosphere located in the first volume space 4 is circulated using the circulation assembly 19, the conduction unit 20 ensuring that an oriented transverse flow with respect to the longitudinal axis or extent of the retort 3 occurs because of the second circulation unit 18.2, as shown by the exemplary arrows 22 drawn in FIG. 2. As a result of this transversely oriented circulation, the furnace atmosphere circulated using the circulation assembly 19 flows past the heating elements 6 in the longitudinal direction thereof and provides a heated flow circulating around the retort 3 with respect to the plane of the drawing according to FIG. 2.

The second circulation unit 18.2 is positioned in a second opening 23 of the furnace housing 2. For a thermal seal of this opening 23, the second circulation unit 18.2 includes a plug 21, which is formed from a material identical to the insulation 15. The entire second circulation unit 18.2 is implemented as a modular and compact unit because of this design, which may be installed in or removed from the second opening 23 of the furnace housing 2 by simple insertion or retraction, respectively.

Both the heating elements 6 and also the second circulation 18.2 advantageously provide, both alone and also in combination, a much more uniform and therefore better heating of the retort 3 and therefore finally also of the batch 14 situated in the retort inner space 3 for the purpose of heat treatment, in contrast to the prior art. This causes a lengthened service life of the retort 3, on the one hand, and an improved treatment result with respect to the batch 14 to be heat treated, on the other hand.

### INDUSTRIAL APPLICABILITY

The effects achieved by the revised configuration according to the invention of heating unit and circulation unit provide a substantial usage value increase and an increased availability of retort furnaces in the applicable industry.

### LIST OF REFERENCE NUMERALS

1 retort furnace
2 furnace housing
2.1 first opening
3 retort
4 first volume space
5 heating unit
6 heating element
7 longitudinal direction
8 longitudinal direction
9 floor
10 charging opening
10.1 cover
11 middle area
12 top area
13 bottom area
14 batch
15 insulation
16 wall
17 second volume space
18.1 first circulation unit
18.2 second circulation unit
19 circulation assembly
20 conduction unit
21 plug
22 arrow
23 second opening
24 segment

1. An electrically heated retort furnace (1) for the heat treatment of metal workpieces,
having a thermally insulated furnace housing (2), which encloses a first volume space (4), having heating assembly (5) for the retort (3) and a first circulation unit (18.1) inside the retort,
the retort (3) enclosed by the first volume space (4) enclosing a second volume space (17), which receives protective and reactive gases and is closable gastight using a door for the charging of a batch (14) of workpieces, as the treatment or batch space for the heat treatment of the workpieces contained in a batch receptacle
wherein the improvement comprises:
a) the heating assembly (5) comprises multiple heating elements (6), which are constructed and arranged so they are at least individually replaceable in the first volume space (4) using closable first openings (2.1) extending through the furnace housing (2) and
b) a second circulation unit (18.2) for the circulation of an atmosphere in the first volume space (4) is constructed and arranged within the furnace housing (2) so it is replaceable as a module through a closable second opening (23), wherein
c) the heating elements (6) and the second circulation unit (18.2) are configured in the first volume space (4) to provide uniform heat transfer to the retort (3).

2. The retort furnace according to claim 1, wherein the heating elements (6) are oriented orthogonally to the longitudinal axis of the retort (3).

3. The retort furnace according to claim 1 or 2, wherein the heating elements (6) have longitudinal axes which are longer than the diameter of the retort (3).

4. The retort furnace according to claim 1, wherein the heating elements (6) have a middle area (11) in relation to their longitudinal axis which is formed so that it is not actively heated.

5. The retort furnace according to claim 1 wherein at least two heating elements (6) are provided along each longitudinal side of the retort (3).

6. The retort furnace according to claim 1 wherein the second circulation unit (18.2) has a circulation assembly (19) and a conduction unit (20).

7. The retort furnace according to claim 6, wherein the conduction unit (20) has a configuration which causes a transverse circulation of the atmosphere in the first volume space (4) relative to the longitudinal axis of the retort (3).
